(19) United States
(12) Patent Application Publication
(10) Pub. No.: US 2005/0144060 A1
(43) Pub. Date: Jun. 30, 2005

(54) System and method for setting user-right, and recording medium

(75) Inventors: Tiros Chen, Shindjan City (TW); Richard Lai, Shindian City (TW); Andy Chen, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 10/998,608

(22) Filed: Nov. 30, 2004

(30) Foreign Application Priority Data
Dec. 31, 2003 (TW) 092137716
Jan. 13, 2004 (CN) 200410000602.3

(51) Int. Cl. G06F 17/60

(52) U.S. Cl. 705/9; 705/8

(57) ABSTRACT

A system for setting user-right is used to set user rights of a plurality of users. The system comprises an account creating module, a group creating module, a role creating module, a function creating module, and a relationship defining module. The account creating module creates a plurality of user accounts corresponding to the users. The group creating module creates at least one group according to the user's organization. The role creating module creates at least one functional role according to jobs or projects of the users. The function creating module creates a plurality of functions corresponding to execution items of the users. The relationship defining module defines that at least one user account is subordinate to the group, and the functional role has the right to execute at least one of the functions. The relationship defining module further creates the relationship between the group and the function role. Furthermore, a method for setting user-right and a recording medium, having a computer executable program for performing the method, are provided.

### CROSS REFERENCE TO RELATED APPLICATIONS

This Non-provisional application claims priority under 35 U.S.C. §119(a) on Patent Application No. 092137716 filed in Taiwan, Republic of China on Dec. 31, 2003, the entire contents of which are hereby incorporated by reference.

### BACKGROUND OF THE INVENTION

1. Field of Invention

The invention relates to a system and a method for authorization and, more particularly, to a system and a method for setting the user-right suitable for multiple users.

2. Related Art

Generally speaking, medium and large-sized enterprises have many employees, and the employees of an enterprise manage various kinds of jobs based on the structure of the whole enterprise. That is, the job contents of different employees are usually different. Therefore, how to connect the contents of the jobs between different employees to establish the organization structure, to set up the user rights, and to distinguish the responsibilities has become a very important issue.

To effectively manage the rights of different users, conventionally a user account is established for each user, and the work items corresponding to the user account is set according to the job contents of the user. Herein, an operator (such as the administrator of the user-right management software) has to record, enter, or modify the work items corresponding to every user account. That is, the work items that the user account has the right to access, one by one.

However, as the business grows, the number of the users of an enterprise increases accordingly. The way for establishing the user rights in the prior art becomes complex and inefficient. When an enterprise grows rapidly or the job contents of its employees vary quickly, the prior art cannot establish and control the updated user rights timely and effectively, and requires a lot of time and manpower to record, enter, and modify the corresponding work items of each user account.

Therefore, how to provide a system and a method for setting user-right, which can effectively establish the connections between the user accounts and their corresponding job contents, has become an important issue that needs to be solved.

### SUMMARY OF THE INVENTION

In view of the above issue, the invention is to provide a system and a method for setting user-right, which can establish the connections between the user accounts and their corresponding job contents effectively.

To achieve the above, the system for setting user-right of multiple users according to the invention includes an account creating module, a group creating module, a role creating module, a function creating module, and a relationship defining module. The account creating module establishes the user accounts corresponding to the users. The group creating module establishes at least one group according to the organization structure of the users. The role creating module establishes at least one functional role according to the job contents of the users. The function creating module establishes a plurality of functions corresponding to the execution items of the users. The relationship defining module sets at least one user account to be subordinate to the group, setting the functional role to has the right to use at least one of the functions, and establishing relationship between the group and the functional role.

In addition, the invention also discloses a method for setting user-right of a plurality of users, which comprises the following steps of: establishing a plurality of user accounts corresponding to the users; establishing at least one group according to organization structure of the users; establishing at least one functional role according to job contents of the users; establishing a plurality of functions corresponding to execution items of the users; setting at least one of the user accounts to be subordinate to the group; setting the functional role to have right to use at least one of the functions; and establishing relationship between the group and the functional role.

The invention further provides a recording medium, which records a computer readable program for setting user-right of a plurality of users. The program is for the computer to perform the above-mentioned method for setting user-right of a plurality of users of the invention.

Based on the above, since the system and method for setting user-right have groups established according to the organization structure of the users and the functional roles established according to the job contents of the users, the user accounts and their corresponding executive items can be created effectively. When the groups, the functional roles and functions are already established, the user right settings can be accomplished by simply establishing the relationships between the user accounts and the groups using the relationship defining module. Therefore, even when the enterprise grows rapidly or the job contents change quickly, the user rights can be controlled and established effectively without consuming excessive time and manpower.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing the system for setting user-right according to an embodiment of the invention;

FIG. 2 is a schematic diagram showing the user rights established by the system for setting user-right according to the embodiment of the invention;

FIG. 3 is a schematic diagram illustrating the user rights of persons in a sales department;

FIG. 4 is a schematic diagram showing other user rights established by the system for setting user-right according to the embodiment of the invention;

FIG. 5 is a flowchart showing the procedure of the method for setting user-right according to an embodiment of the invention; and

FIG. 6 is a flowchart showing the procedure of the method for setting user-right according to another embodiment of the invention.

### DETAILED DESCRIPTION OF THE INVENTION

The system and method for setting user-right according to the embodiments of the invention will be described below with reference to relevant drawings, wherein the same elements are referred with the same reference numbers.

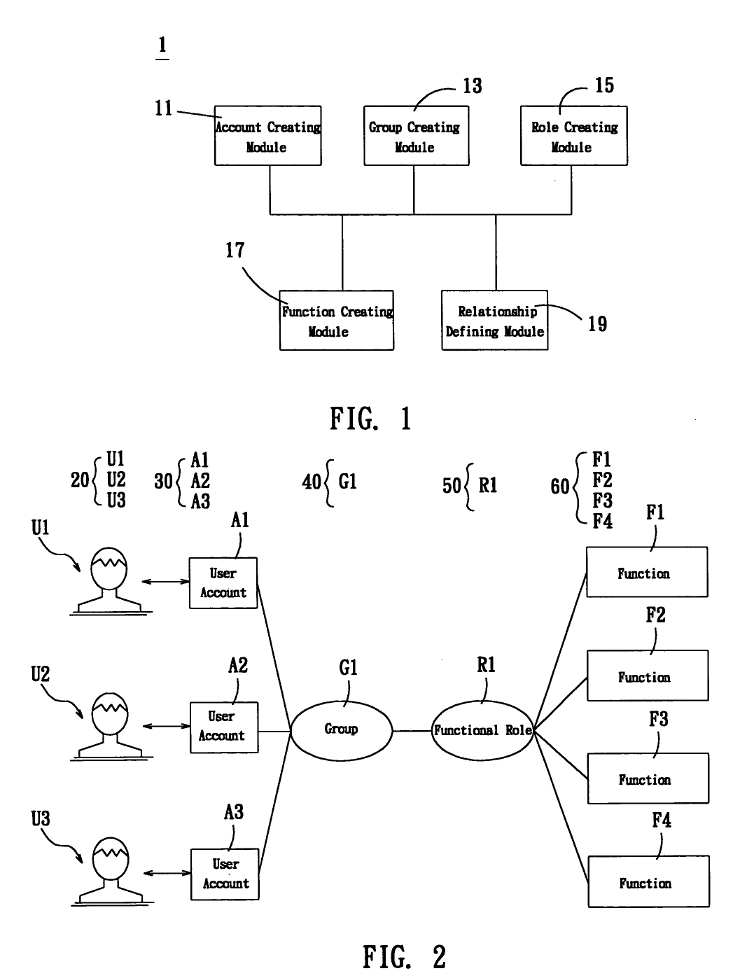

Please refer to FIG. 1, which shows a system 1 for setting user-right according to an embodiment of the invention. The system 1 for setting user-right, which is used for authorization, at least includes an account creating module 11, a group creating module 13, a role creating module 15, a function creating module 17, and a relationship defining module 19. In this embodiment, the system 1 for setting user-right sets the user rights of a plurality of users 20.

As shown in FIG. 2, the account creating module 11 establishes the user accounts 30 corresponding to the users 20. The group creating module 13 establishes a plurality of groups 40 according to the organization structure of the users 20. The role creating module 15 establishes a plurality of functional roles 50 according to the job contents of the users 20. The function creating module 17 establishes a plurality of functions 60 corresponding to the execution items of the users 20. The relationship defining module 19 sets a plurality of user accounts 30, wherein at least on user account 30 is subordinate to at least one group 40. The relationship defining module 19 also sets at least one functional role 50 to have the right to use at least one function 60, and establishes the relationship between at least one group 40 and at least one functional role 50.

For example, the account creating module 11 corresponds users U1 to U3 to user accounts A1 to A3, respectively. The group creating module 13 establishes a group G1 according to the organization structure of the users U1 to U3. The role creating module 15 establishes a functional role R1 according to the job contents of the users U1 to U3. The function creating module 17 establishes functions F1 to F4. The relationship defining module 19 sets the user accounts A1 to A3 to be subordinate to the group G1, sets the functional role R1 to have the rights to use the functions F1 to F4, and establishes the relationship between the group G1 and the functional role R1, that is, whether the group G1 corresponds to the functional role R1.

It should be noted that the system 1 for setting user-right could be implemented in an electronic apparatus, such as a conventional computer that includes a central processing unit (CPU), a storage device, an input device and an output device. The CPU could be in any conventional architecture, such as including an arithmetic logic unit (ALU), a register and a controller, for performing various kinds of operations and to control the operations of other devices in the electronic apparatus. The storage device could be anyone or the combination of computer-readable data storage devices, such as a hard disc drive, an optical disc drive, a dynamic random access memory (DRAM), an electrically erasable programmable read-only memory (E²PROM), or the combinations thereof. The input device could be any device that allows a user to input data or instructions to the electronic apparatus, such as a keyboard or a mouse.

The modules of the present embodiment could be software modules stored in the storage device. The CPU accesses the software modules, and realizes the functions of the modules through the devices in the electronic apparatus, such as the input device, the storage device, the output device or other software modules. However, it should be noted that persons having ordinary skill in the art may design firmware or hardware, such as an application-specific integrated circuit (ASIC), to realize the function of the software modules mentioned above without departing from the spirit and the scope of the invention. Furthermore, the user accounts 30, groups 40, functional role 50, functions 60, and the relationship thereof created by the system 1 could be stored in any computer-accessible database, such as an electronic database stored in the storage device mentioned above.

The system 1 mentioned above is not limited to be realized by hardware, software, firmware or the combinations thereof.

To make the content of the invention more comprehensive, the operation procedure of the system 1 for setting user-right will be described below using an example.

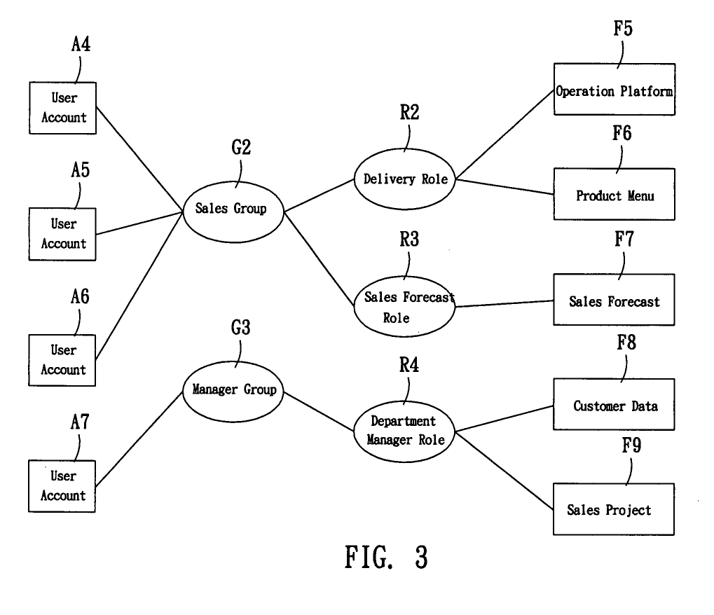

Please refer to FIG. 3, firstly, the account creating module 11 establishes user accounts A4 to A7 for users in the sales department, which includes one department manager and three staffs. Among the user accounts A4 to A7, the user accounts A4 to A6 correspond to the three staffs respectively, while the user account A7 corresponds to the department manager.

The group creating module 13 establishes groups according to the organization structure of the sales department. The established groups include a sales group G2 and a manager group G3.

The role creating module 15 establishes functional roles according the job contents of the sales department. Since the sales department has delivery agents responsible for delivering products to customers, sales forecast agents responsible for sales forecasting, and department managers responsible for managing the whole department, the functional roles the role creating module 15 established include a delivery role R2, a sales forecast role R3, and a department manager role R4.

The function creating module 17 establishes functions according to the execution items of the sales department, including “operation platform” F5, “product menu” F6, “sales forecast” F7, “customer data” F8, and “sales project” F9.

Finally, the relationship defining module 19 sets the relationships between the user accounts, the groups, the functional roles and the functions mentioned above. In the present embodiment, the user accounts A4 to A6 of the three staffs is subordinate to the sales group G2, and the user account A7 of the department manager is subordinate to the manager group G3. The delivery role R2 has the right to use the operation platform F5 and the product menu F6. The sales forecast role R3 has the right to use the sales forecast F7. The department manager role R4 has the right to use the customer data F8 and the sales project F9. The sales group G2 has a relationship with the delivery role R2 and the sales forecast role R3, while the manager group G3 has a relationship with the department manager role R4.

Therefore, the three staffs have the right to use the operation platform F5, the product menu F6 and the sales forecast F7. They can use the function of the operation platform F5 to handle the product delivery process, use the function of the product menu F6 to examine the products of the enterprise, and use the function of the sales forecast F7 to input the sales forecast of the products. The department manager has the right to use the customer data F8 and the sales project F9. He or she can obtain relevant information of the customers using the function of the customer data F8, and establish or examine the sales project of a product using the function of the sales project F9.

As described above, except for establishing groups in view of the organization structure of the users, the system 1 for setting user-right according to the embodiment of the invention further establishes functional roles in view of the job contents of the users. Therefore, the relationships between the user accounts and the job items can be established effectively. When the groups, the functional roles and the functions have been established, the right of a new user can be set by simply using the relationship defining module to set the new user account to be subordinate to a certain group, or to set the new user account to have a certain functional role or a certain function. For example, when a new sales person joins the sales department, a new user account with appropriate rights can be set immediately using the system 1 for setting user-right.

Moreover, the group creating module 13 may further establish at least one subgroup according to the organization structure of the users 20. Here, the relationship defining module 19 may set the relationship between the user accounts 30 and the subgroup, and set the subgroup to be subordinate to at least one group 40 (when a plurality of groups 40 exists). The relationship defining module 19 may directly establish the relationship between at least one subgroup and at least one functional role 50, or set the right of at least one group 40 or subgroup to use at least one function 60. Comparatively, the role creating module 15 may also establish at least one functional sub-role according to the job content of the users 20. Here, the relationship defining module 19 sets at least one functional sub-role to have the right to use at least one function 60, and sets at least one functional sub-role to be subordinate to at least one functional role 50. The relationship defining module 19 may directly establish the relationship between at least one functional sub-role and at least one group 40, or the relationship between the user accounts 30 and at least one functional role 50 or at least one functional sub-role.

It should be noted that the present embodiment introduces the concept of “direct connect”. That is, when a multilevel architecture including at least three of the functional role, functional sub-role, group and subgroup exists, the connections between not-neighboring levels, such as a group to a functional sub-role or between a subgroup and a functional sub-role, can be established directly without the neighboring-level connection constraint. The advantage is that when adding another job to a person in one department, such as assigning a sales agent the task of internal training, one can simply establish a connection from this person to this job without creating a new group and then assigning necessary jobs to this additionally-created group.

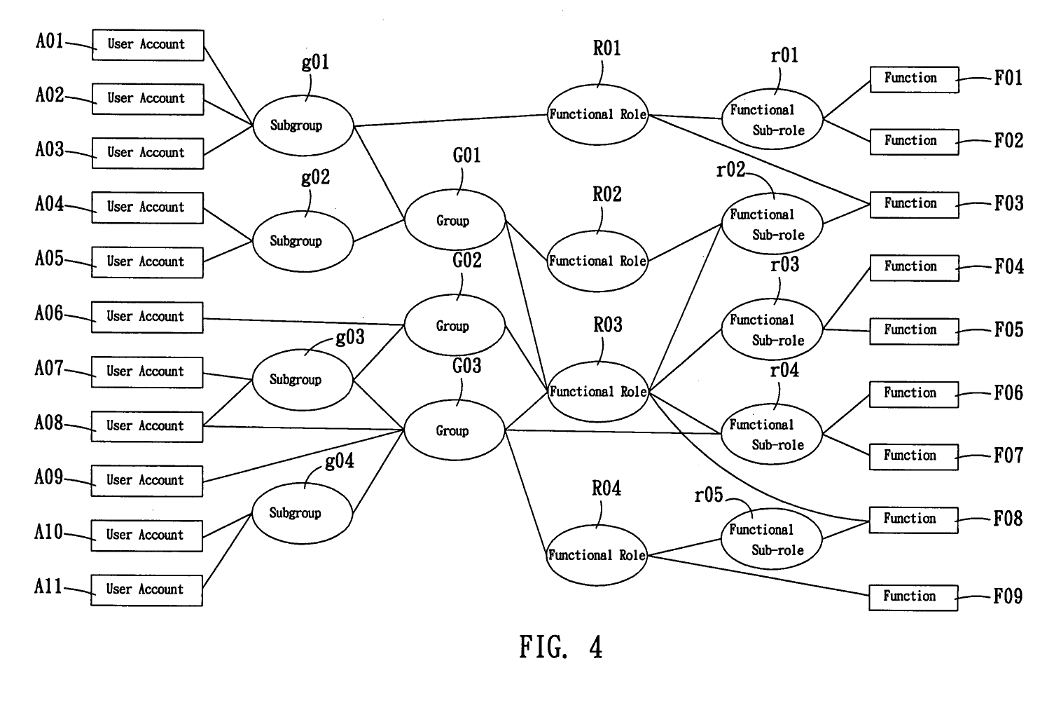

From the above, the user rights set by the system 1 for setting user-right according to the embodiment of the invention is shown in FIG. 4. FIG. 4 shows user accounts A01 to A11, subgroups g01 to g04, functional roles R01 to R04, functional sub-roles r01 to r05, functions F01 to F09, and the relationships between them.

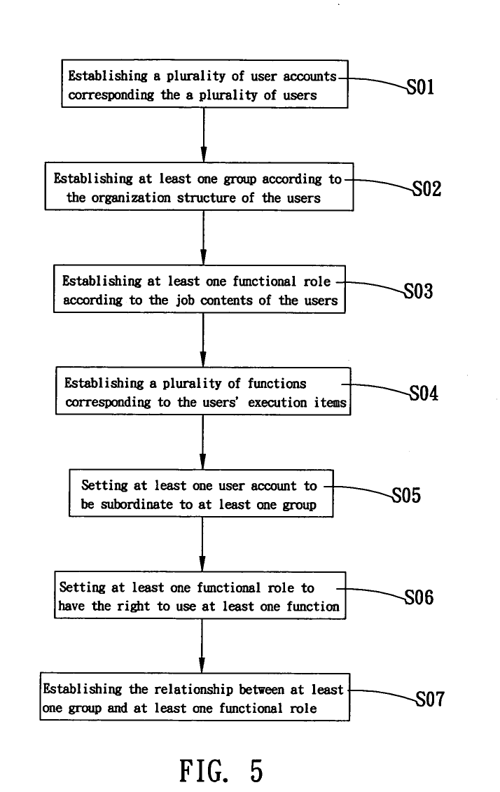

FIG. 5 shows another aspect of the embodiment of the invention, which is a method for setting user-right realized by the system 1 for setting user-right described above. The method includes establishing a plurality of user accounts corresponding the a plurality of users (S01), establishing at least one group according to the organization structure of the users (S02), establishing at least one functional role according to the job contents of the users (S03), establishing a plurality of functions corresponding to the users' execution items (S04), setting at least one user account to be subordinate to at least one group (S05), setting at least one functional role to have the right to use at least one function (S06), and establishing the relationship between at least one group and at least one functional role (S07). It should be noted that since this method is realized by the system 1 described above, the detailed description of each step is the same as that in the above paragraphs, and is omitted here for concise purpose.

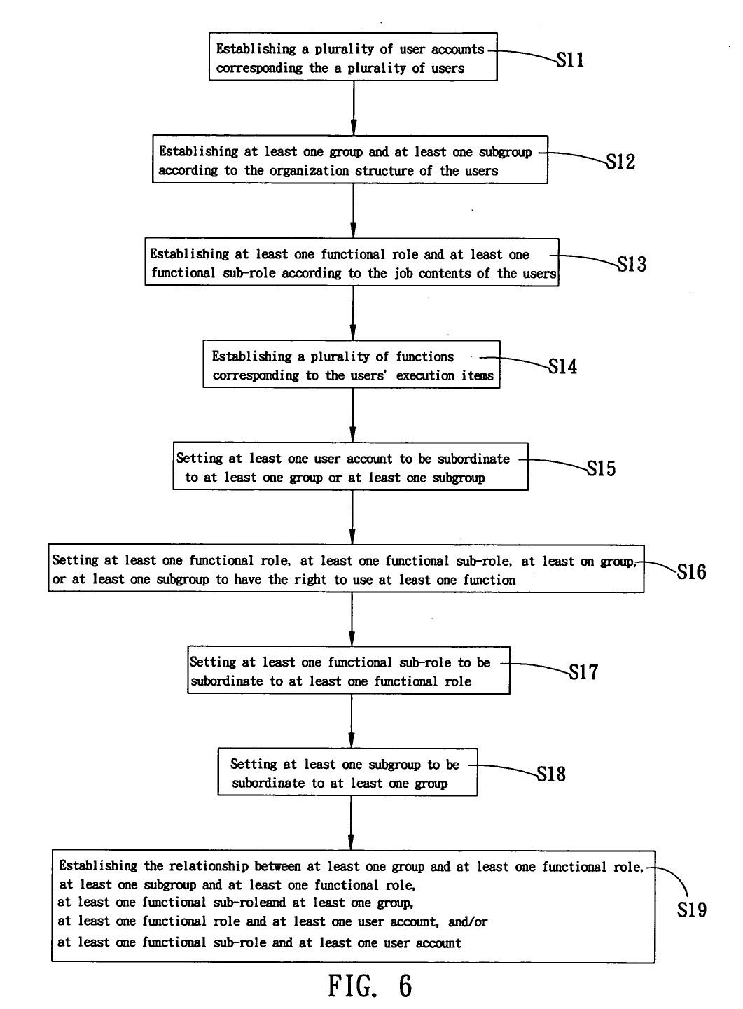

FIG. 6 shows the method for setting user-right according to another embodiment of the invention. The method includes establishing a plurality of user accounts corresponding the a plurality of users (S11), establishing at least one group and at least one subgroup according to the organization structure of the users (S12), establishing at least one functional role and at least one functional sub-role according to the job contents of the users (S13), establishing a plurality of functions corresponding to the users' execution items (S14), setting at least one user account to be subordinate to at least one group or at least one subgroup (S15), setting at least one functional role, at least one functional sub-role, at least on group, or at least one subgroup to have the right to use at least one function (S16), setting at least one functional sub-role to be subordinate to at least one functional role (S17), setting at least one subgroup to be subordinate to at least one group (S18), and establishing the relationship between at least one group and at least one functional role, at least one subgroup and at least one functional role, at least one functional sub-role and at least one group, at least one functional role and at least one user account, and/or at least one functional sub-role and at least one user account (S19). It should be noted that the method shown in FIG. 6 might be used to establish the user rights shown in FIG. 4.

In addition, the invention also provides a recording medium, which records a computer readable program for setting user-right of a plurality of users. The program at least includes an account creating program segment, a group creating program segment, a role creating program segment, a function creating program segment, and a relationship defining program segment. The account creating program segment is for the computer to establish user accounts corresponding to the users. The group creating program segment is for the computer to establish at least one group according to organization structure of the users. The role creating program segment is for the computer to establish at least one functional role according to job contents of the users. The function creating program segment is for the computer to establish a plurality of functions corresponding to at least one execution item of the users. The relationship defining program segment is for the computer to set at least one of the user accounts to be subordinated to the group, to set the functional role to have the right to use at least one of the functions, and to establish relationship between the group and the functional role. In this case, the computer executing the program for setting user-right could be the above-mentioned system for setting user-right (see FIG. 1).

To sum up, since the system and method for setting user-right have groups established according to the organization structure of the users and the functional roles established according to the job contents of the users, the user accounts and their corresponding executive items can be created effectively. When the groups, the functional roles and functions are already established, the user right settings can be accomplished by simply establishing the relationships between the user accounts and the groups using the relationship defining module. Therefore, even when the enterprise grows rapidly or the job contents change quickly, the user rights can be controlled and established effectively without consuming excessive time and manpower.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A system for setting rights of a plurality of users, comprising:
an account creating module for establishing user accounts corresponding to the users;
a group creating module for establishing at least one group according to organization structure of the users;
a role creating module for establishing at least one functional role according to job contents of the users;
a function creating module for establishing a plurality of functions corresponding to at least one execution item of the users; and
a relationship defining module for setting at least one of the user accounts to be subordinate to the group, setting the functional role to have the right to use at least one of the functions, and establishing relationship between the group and the functional role.

2. The system according to claim 1, wherein:
the group creating module further establishes a subgroup according to the organization structure of the users; and
the relationship defining module further sets relationships between the user accounts and the subgroup.

3. The system according to claim 2, wherein the relationship defining module further sets relationship between the subgroup and the functional role.

4. The system according to claim 2, wherein the relationship defining module further sets the group or the subgroup to have right using the function.

5. The system according to claim 1, wherein the role creating module further establishes at least one functional sub-role according to job contents of the users.

6. The system according to claim 5, wherein the relationship defining module sets the functional sub-role to have right using the function, and sets the functional sub-role to be subordinate to the functional role.

7. The system according to claim 6, wherein the relationship defining module further establishes relationship between the functional sub-role and the group.

8. The system according to claim 6, wherein the relationship defining module further establishes relationship between at least one user account and the functional role or the functional sub-role.

9. A method for setting rights of a plurality of users, comprising:
establishing a plurality of user accounts corresponding to the users;
establishing at least one group according to organization structure of the users;
establishing at least one functional role according to job contents of the users;
establishing a plurality of functions corresponding to execution items of the users;
setting at least one of the user accounts to be subordinate to the group;
setting the functional role to have right to use at least one of the functions; and
establishing relationship between the group and the functional role.

10. The method according to claim 9, further comprising:
establishing at least one subgroup according to the organization structure of the users;
setting relationship between the user accounts and the subgroup; and
setting the subgroup to be subordinate to the group.

11. The method according to claim 10, further comprising:
establishing relationship between the subgroup and the functional role.

12. The method according to claim 10, further comprising:
setting the group or the subgroup to have right using at least one of the functions.

13. The method according to claim 9, further comprising:
establishing at least one functional sub-role according to the job contents of the users.

14. The method according to claim 13, further comprising:
setting the functional sub-role to have right to use at least one of the functions; and
setting the functional sub-role to be subordinate to the functional role.

15. The method according to claim 14, further comprising:
establishing relationship between the functional sub-role and the group.

16. The method according to claim 14, further comprising:
establishing relationship between at least one of the user accounts and the functional role or the functional sub-role.

17. A recording medium, which records a computer readable program for setting rights of a plurality of users, the program comprising:
an account creating program segment for the computer to establish user accounts corresponding to the users;
a group creating program segment for the computer to establish at least one group according to organization structure of the users;
a role creating program segment for the computer to establish at least one functional role and at least one functional sub-role according to job contents of the users;
a function creating program segment for the computer to establish a plurality of functions corresponding to at least one execution item of the users; and
a relationship defining program segment for the computer to set at least one of the user accounts to be subordinate to the group, to set the fuictional role and the functional sub-role to have the right to use at least one of the functions, to establish relationships between the group and the functional role, between the functional sub-role and the group, and between at least one user account and the functional role and the functional sub-role, and to set the functional sub-role to be subordinate to the fuinctional role.

18. The recording medium according to claim 17, wherein:
the group creating program segment for the computer to further establish a subgroup according to the organization structure of the users; and
the relationship defining program segment for the computer to further set relationships between the user accounts and the subgroup.

19. The recording medium according to claim 18, wherein the relationship defining program segment for the computer to further set relationship between the subgroup and the functional role.

20. The recording medium according to claim 18, wherein the relationship defining program segment for the computer to further set the group or the subgroup to have right using the function.
